(19) United States
(12) Patent Application Publication
(10) Pub. No.: US 2012/0198133 A1
(43) Pub. Date: Aug. 2, 2012

(54) ELECTRONIC DEVICE WITH EXPANDABLE MEMORY CAPACITY AND AN EXPANSION METHOD THEREOF

(75) Inventors: CHENG-HAO CHOU, Tu-Cheng (TW); CHIH-SAN CHIANG, Tu-Cheng (TW); MING-TSUNG CHEN, Tu-Cheng (TW)

(73) Assignee: HON HAI PRECISION INDUSTRY CO., LTD., Tu-Cheng (TW)

(21) Appl. No.: 13/191,464

(22) Filed: Jul. 27, 2011

(30) Foreign Application Priority Data
Jan. 28, 2011 (CN) 201110031588.3

(51) Int. Cl. G06F 12/02

(52) U.S. Cl. 711/103; 711/173; 711/170; 711/E12.001; 711/E12.008; 711/E12.002

(57) ABSTRACT

An electronic device includes a processor, an internal memory for storing system information and installing programs, and a memory expansion interface for connecting an expansion memory. The expansion memory is partitioned into at least one region to expand the internal memory. The internal memory is partitioned into a system region and a user region; the system region is used to store system information while the user region can be controlled and used by a user. The processor further includes a detection unit and a memory management unit. The detection unit detects the connection of the expansion memory to the memory expansion interface, and the memory management unit determines whether the expansion memory has been previously configured to expand the internal memory, and if not, the memory management unit associates the expansion memory with the internal memory to expand the internal memory.

### BACKGROUND

1. Technical Field

The present disclosure relates to an electronic device, and particularly, to an electronic device with expandable internal memory.

2. Description of Related Art

Electronic devices, like smart phones or tablet PCs, have internal memory for storing information. Generally, the internal memories are partitioned into two regions, a system region and a user region; the system region is used to store system information as well as pre-installed programs, and a user can utilize the user region to install new programs downloaded from the internet.

However, because of the limited internal memory capacity, if the user region becomes full, the user needs to uninstall some existing programs before installing new ones.

Therefore, what is needed is an electronic device with expandable internal memory and a method to expand the capacity of the internal memory.

### BRIEF DESCRIPTION OF THE DRAWINGS

The components in the drawings are not necessarily drawn to scale, the emphasis instead being placed upon clearly illustrating the principles of an electronic device with expandable internal memory. Moreover, in the drawings, like reference numerals designate corresponding parts throughout the several views.

FIG. 1 is a block diagram of an electronic device in accordance with an exemplary embodiment.

FIG. 2 is a flowchart of a memory expansion method in accordance with an exemplary embodiment.

### DETAILED DESCRIPTION

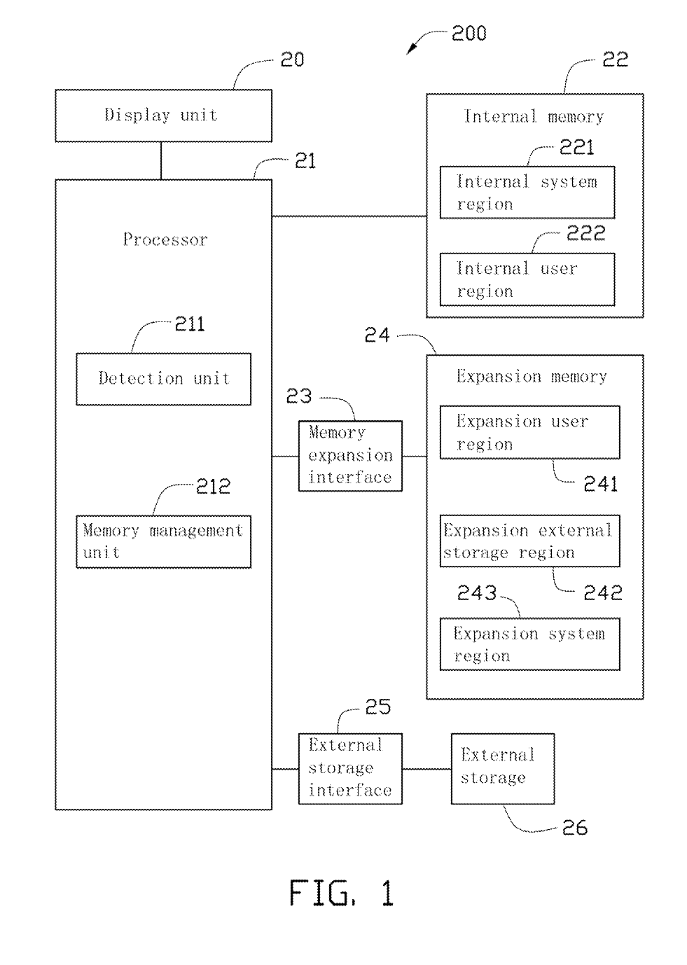

Referring to FIG. 1, an electronic device 200 includes a display unit 20, a processor 21 having a detection unit 211 and a memory management unit 212, an internal memory 22 connected to the processor 21, an expansion memory 24 connected to the processor 21 through a memory expansion interface 23, and an external storage 26 connected to the processor 21 through an external storage interface 25.

In one embodiment, the internal memory 22 is a flash memory partitioned into an internal system region 221 and an internal user region 222, wherein system information and pre-installed programs of the electronic device 200 are stored in the internal system region 221, and users can only utilize the internal user region 222 but not the internal system region 221 for installing new programs. The external storage 26 is for storing data, like pictures or videos, saved by the user. In the present embodiment, the electronic device 200 is an ANDROID device and the programs are applications downloaded from the Android Market or other resources.

The processor 21 can associate the expansion memory 24 with the internal memory 22 and the external storage 26 to expand the capacity of the internal memory 22 and the external memory 26. In one embodiment, the detection unit 211 detects the connection between the expansion memory 24 and the memory expansion interface 23, and the memory management unit 212 determines whether the expansion memory 24 is associated with the internal memory 22. If the expansion memory 24 is not associated with the internal memory 22, the memory management unit 212 associates the expansion memory 24 with the internal user region 222 of internal memory 22; therefore, when the internal user region 222 is filled, the user can install new applications in the expansion memory 24. In the present embodiment, the expansion memory 24 is a micro SD card, and the user can replace the micro SD card with another card of different capacity on demand. The memory management unit 212 determines whether the expansion memory 24 is associated with the internal memory 22 by acquiring the header of the expansion memory 24. In another embodiment, the memory management unit 212 formats whole or part of the expansion memory 24 to an appropriate file system corresponding to the internal memory 22 before associating the expansion memory 24 with the internal memory 22.

In another embodiment, the expansion memory 24 is partitioned by the memory management unit 212 into an expansion user region 241 and an expansion system region 243 with a pre-determined ratio which can be modified by the user, and then associates the expansion user region 241 and the expansion system region 243 to the internal user region 222 and the internal system region 221, respectively. By way of example, the expansion memory 24 is an 8GB micro SD card, and 4GB are for the expansion user region 241 and the other 4GB are for the expansion system region 243, therefore, the electronic device 200 gets 4GB extra capacity for the internal system region 221 and 4GB extra capacity for the internal user region 222. In another embodiment, when the expansion memory 24 is connected, the processor 21 controls the display unit 20 to show a partition control interface which allows the user to manually set the partition ratio of the expansion memory 24.

In another embodiment, the expansion memory 24 can be partitioned into more than two regions. By way of example, the expansion memory 24 can be partitioned into the expansion user region 241, the expansion system region 243, and an expansion external storage region 242 associated with the external storage 26.

In another embodiment, if the user chooses not to associate the expansion memory 24 with the internal memory 22 or the external storage 26, the expansion memory 24 performs as another external storage 26 when connected to the processor 21.

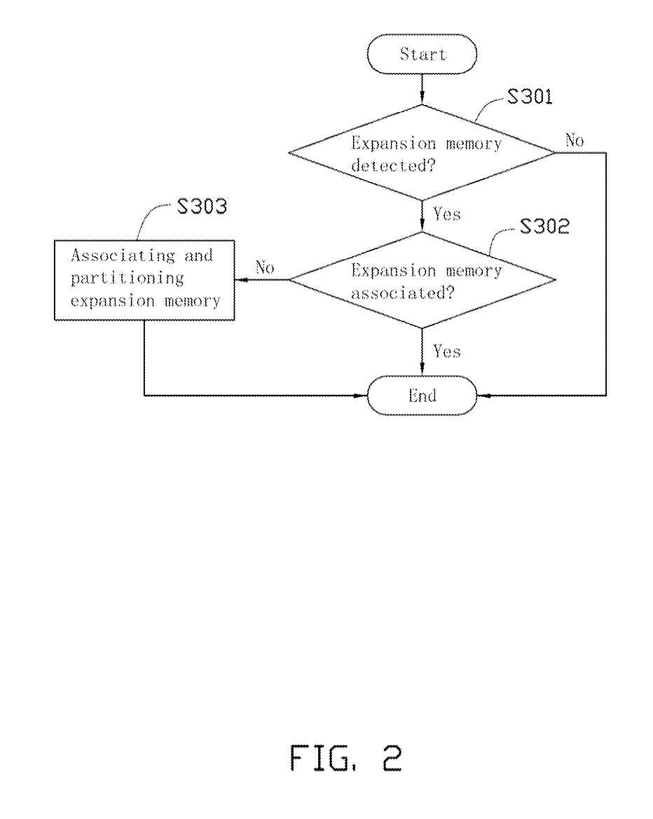

FIG. 2 is a flowchart of a method for expanding the internal memory 22 of the electronic device 200 in accordance with one embodiment; the process of the method is initiated after the electronic device 200 is booted, or being manually initiated by the user. The method comprising following steps:

In step S301, the detection unit 211 detects whether the expansion memory 24 is connected to the memory expansion interface 23.

In step S302, the memory management unit 212 determines whether the expansion memory 24 is associated with the internal memory 22: if yes flow ends, if no go to step S303.

In step S303, the memory management unit 212 associates the expansion memory 24 with the internal memory 22, and partitions the expansion memory 24 into the expansion user region 241 and the expansion system region 243 to expand the internal memory 22.

Therefore, the electronic device 200 can expand the capacity of the internal memory 22 with the expansion memory 24 when the internal memory 22 is filled. The expansion user region 241 can be installed with new applications without having to first uninstall other wanted programs or data.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device, comprising:
a processor for detecting and managing a memory system of the electronic device;
an internal memory for storing system information and installing programs; and
a memory expansion interface, wherein the memory expansion interface is used for connecting an expansion memory; and the expansion memory being partitioned into at least one region to expand the internal memory.

2. The electronic device as claimed in claim 1, wherein the internal memory is partitioned into a system region and a user region; the system region is used to store system information while the user region can be controlled by a user for program installation.

3. The electronic device as claimed in claim 1, wherein the processor further comprises a detection unit and a memory management unit; the detection unit detects the connection of the expansion memory to the memory expansion interface, and the memory management unit determines whether the expansion memory is associated to the internal memory; the memory management unit partitions the expansion memory into the at least one region to expand the internal memory.

4. The electronic device as claimed in claim 2, wherein the at least one region comprises an expansion user region for expanding the user region of the internal memory.

5. The electronic device as claimed in claim 2, wherein the at least one region comprises an expansion system region for expanding the system region of the internal memory.

6. The electronic device as claimed in claim 1, wherein the electronic device further comprises an external storage interface for connecting with an external storage.

7. The electronic device as claimed in claim 6, wherein the at least one region comprises an expansion storage region for expanding the external storage.

8. The electronic device as claimed in claim 1, wherein the internal memory is flash memory.

9. The electronic device as claimed in claim 1, wherein the electronic device is an ANDROID device.

10. A method for managing an expansion memory, comprising:
detecting a connection of the expansion memory with a electronic device; and
determining whether the expansion memory is associated with a memory system of the electronic device; if the expansion memory is not associated with the memory system, associating the expansion memory with the memory system to expand capacity of the memory system to the expansion memory.

11. The method as claimed in claim 10, further comprising:
Partitioning the expansion memory into at least one expansion region; and
Associating the at least one expansion region to a corresponding region of the memory system.

12. The method as claimed in claim 11, further comprising:
formatting the expansion memory to a file system in accordance with the memory system.

13. The method as claimed in claim 11, wherein the memory system is an internal memory of the electronic device.

14. The method as claimed in claim 13, wherein one of the at least one expansion region is an expansion user region; the expansion user region is associated with an internal user region of the internal memory for installing programs.

15. The method as claimed in claim 13, wherein one of the at least one expansion region is an expansion system region; the expansion system region is associated with an internal system region of the internal memory for storing system information.

16. The method as claimed in claim 11, wherein the memory system is an external storage.

17. The method as claimed in claim 16, wherein one of the at least one expansion region is an expansion external storage region; the external storage is associated with the external storage for storing information.
